(19) United States
(12) Patent Application Publication
(10) Pub. No.: US 2024/0078360 A1
(43) Pub. Date: Mar. 7, 2024

(54) MODELING METHOD AND USE METHOD FOR IDENTIFICATION MODEL OF TIRE CAPACITY, AND RELATED DEVICE

(71) Applicants: Amir Khajepour, Waterloo (CA); Ehsan Hashemi, Waterloo (CA); Jilin University, Changchun (CN)

(72) Inventors: Nan Xu, Changchun (CN); Amir Khajepour, Waterloo (CA); Ehsan Hashemi, Waterloo (CA)

(21) Appl. No.: 18/261,730

(22) PCT Filed: Jun. 4, 2021
(86) PCT No.: PCT/CN2021/098446

§ 371 Date: Jul. 17, 2023

(30) Foreign Application Priority Data
Jan. 18, 2021 (CN) 202110062515.4

(51) Int. Cl. G06F 30/27; G06F 30/15

(52) U.S. Cl. CPC G06F 30/27; G06F 30/15; G06F 2119/14

(57) ABSTRACT

A method for modeling an identification model of a tire capacity, including: obtaining tire test data, wherein the tire test data comprises a tire angular velocity, a wheel effective radius, a tire slip angle, a wheel center velocity, a tire longitudinal force, a tire lateral force and a tire vertical force; obtaining a total slip ratio and a normalized tire force according to the tire test data; obtaining a tire capacity corresponding to the total slip ratio and the normalized tire force according to the tire test data; and performing training using the total slip ratio, the normalized tire force, and the tire capacity through a machine learning algorithm to complete the modeling of the identification model of the tire capacity.

### CROSS REFERENCE

The present disclosure is a National Stage of International Application No. PCT/CN2021/098446 filed on Jun. 4, 2021, and claims priority to Chinese Patent Application No. 202110062515.4, entitled “Modeling method and use method for identification model of tire capacity, and related device”, filed Jan. 18, 2021, and both the entire contents of which are incorporated herein by reference.

### TECHNICAL FIELD

The present disclosure relates to the field of computer and communication technology, particularly, to a method for modeling and using an identification model of a tire capacity, an apparatus, a computer-readable storage medium and an electronic device.

### BACKGROUND

In ground vehicle movement, the identification of the tire capacity may provide valid information about the current tire capacity associated with the tire attachment boundary, and the tire attachment boundary is directly related to the road condition. Thus, estimation of the tire capacity is of great importance to design and analysis of active safety systems (such as anti-lock brake systems (ABS) and electronic stability control systems (ESP)).

It should be noted that the information disclosed in the foregoing background section is merely intended to enhance the understanding of the background of the present disclosure and may therefore include information that does not constitute the related art known to those of ordinary skill in the art.

### SUMMARY

According to an aspect of the present disclosure, there is provided a method for modeling an identification model of a tire capacity, including:
obtaining tire test data, wherein the tire test data includes a tire angular velocity, a wheel effective radius, a tire slip angle, a wheel center velocity, a tire longitudinal force, a tire lateral force and a tire vertical force;
obtaining a total slip ratio and a normalized tire force according to the tire test data;
obtaining a tire capacity corresponding to the total slip ratio and the normalized tire force according to the tire test data;
performing training using the total slip ratio, the normalized tire force, and the tire capacity through a machine learning algorithm to complete the modeling of the identification model of the tire capacity.

According to an aspect of the present disclosure, there is provided a method for using an identification model of a tire capacity, including:
obtaining tire data;
obtaining a total slip ratio and a normalized tire force according to the tire data;
obtaining the tire capacity using the identification model of the tire capacity according to the total slip ratio and the normalized tire force.

According to an aspect of the present disclosure, there is provided an electronic device, including:
one or more processors;
a storage apparatus, configured to store one or more programs that, when executed by the one or more processors, cause the one or more processors to implement the method according to any one of the embodiments described above.

According to an aspect of the present disclosure, there is provided a computer-readable storage medium having stored with a computer program that, when executed by a processor, implements the method according to any one of the embodiments described above.

It should be understood that the foregoing general description and the following detailed description are merely exemplary and illustrative and are not intended to limit the present disclosure.

### BRIEF DESCRIPTION OF THE DRAWINGS

The following drawings describe some illustrative embodiments of the present disclosure, in which same reference numerals represent same elements. These described embodiments are intended to be example embodiments of the present disclosure and are not intended to be limiting in any way.

FIG. 1 shows a schematic diagram of an exemplary system architecture that may employ the method for modeling the identification model of the tire capacity according to embodiments of the present disclosure;

FIG. 2 shows a schematic structural diagram of a computer system suitable for implementing the electronic device according to embodiments of the present disclosure;

FIG. 3 schematically shows a flow chart of the method for modeling the identification model of the tire capacity according to an embodiment of the present disclosure;

FIG. 4 shows a diagram of curves of the tire longitudinal force versus the longitudinal slip ratio under five types of road surface conditions obtained through tests;

FIG. 5 shows the relationship between the tire longitudinal force and the longitudinal slip ratio under different loads obtained through tests;

FIG. 6 shows a diagram of curves of the tire longitudinal force versus the longitudinal slip ratio at different slip angles under combined slip conditions obtained through tests;

FIG. 7 shows a diagram of curves of tire lateral force versus longitudinal slip ratio at different slip angles under combined slip conditions obtained through tests;

FIG. 8 shows a method for unified processing of the tire data and a method for determining the tire capacity;

FIG. 9 shows a schematic diagram of a classification method for identifying the tire capacity based on a data normalization method under combined slip conditions on a dry road surface condition;

FIG. 10 shows a schematic diagram of tire capacity classification results under pure longitudinal slip condition;

FIG. 11 shows a schematic diagram of tire capacity classification results under pure lateral slip condition;

FIG. 12 is a diagram of curves obtained by processing the tire test data collected on a snowy road surface through a unified method;

FIG. 13 is a schematic diagram of data-driven based tire capacity identification adopting a random forest algorithm;

FIG. 14 is an identification result of the tire capacity under pure longitudinal slip condition;

FIG. 15 is an identification result of the tire capacity under combined slip conditions with tire data collected under a dry road surface as input;

FIG. 16 is an identification result of the tire capacity under combined slip conditions with tire data collected under an icy and snowy road as input;

FIG. 17 shows a flow chart of vehicle-mounted operation of a tire capacity identification module;

FIG. 18 is an identification result of the tire capacity obtained with test data collected under vehicle driving/braking conditions on a dry road surface as input;

FIG. 19 is an identification result of the tire capacity obtained with test data collected under the double lane-change maneuver on an icy and snowy road surface as input;

FIG. 20 schematically shows a block diagram of an apparatus for identifying the tire capacity according to an embodiment of the present disclosure.

### DETAILED DESCRIPTION

Example embodiments will now be described more fully with reference to the accompanying drawings. Example embodiments, however, can be implemented in various forms and should not be construed as being limited to the examples set forth here; by contrast, these embodiments are provided so that the present disclosure will be more comprehensive and complete and will fully convey the concepts of the exemplary embodiments to those skilled in the art.

Furthermore, the described features, structures, or properties may be combined in one or more embodiments in any suitable manner. In the following description, numerous specific details are provided to provide a thorough understanding of the embodiments of the present disclosure. However, those skilled in the art will recognize that the present disclosure may be practiced without one or more of the specific details, or other methods, components, apparatuses, steps, and the like may be employed. In other cases, common-known methods, apparatuses, implementations, or operations are not shown or described in detail to avoid obscuring various aspects of the present disclosure.

The block diagrams shown in the drawings are merely functional entities, without necessarily having to correspond to physically separate entities, i.e., the functional entities may be implemented in software, in one or more hardware modules or integrated circuits, or in different networks and/or processor devices and/or microcontroller devices.

The block diagrams shown in the drawings are only functional entities and do not necessarily correspond to a physically independent entity. That is, these functional entities can be implemented in the form of a software, or in one or more hardware modules or integrated circuits, or in different network and/or processor apparatuses and/or microcontroller apparatuses.

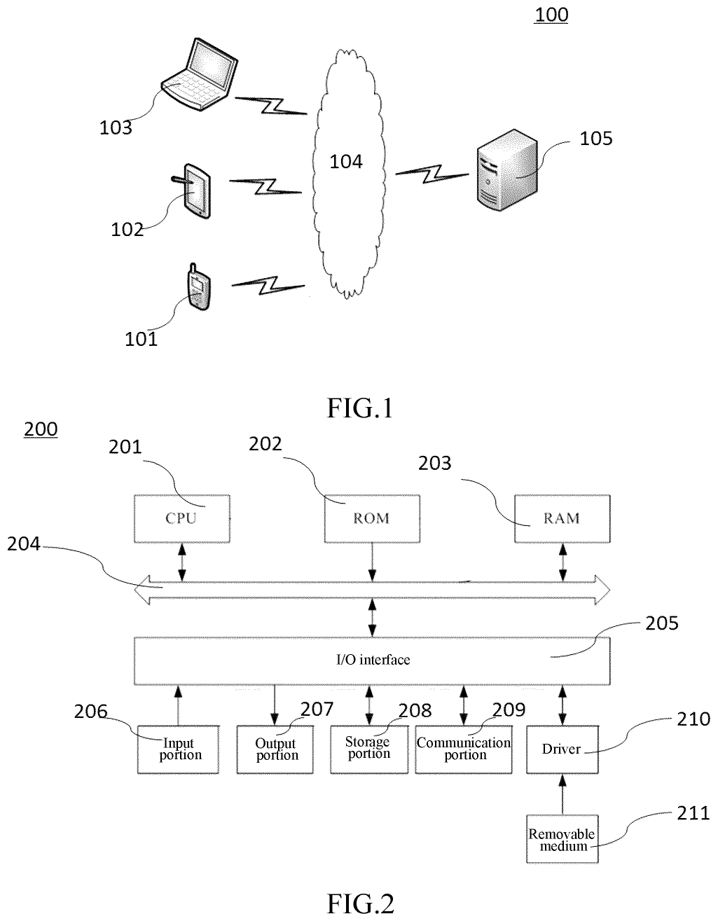

FIG. 1 shows a schematic diagram of an exemplary system architecture 100 that may employ the method for modeling the identification model of the tire capacity according to the embodiments of the present disclosure.

In related art, the method for identifying the tire capacity cannot identify the tire capacity in linear and nonlinear regions and under all conditions of pure working conditions and combined slip conditions. The embodiments of the present disclosure provide a method for modeling and using an identification model of a tire capacity, an apparatus, a computer-readable storage medium and an electronic equipment, which can realize the modeling of the identification model of the tire capacity.

Other features and advantages of the present disclosure will become apparent from the following detailed description, or may be learned partially by the practice of the present disclosure.

As shown in FIG. 1, the system architecture 100 may include one or more of the terminal devices 101, 102 and 103, a network 104, and a server 105. The network 104 is a medium used to provide a communication link between the terminal devices 101, 102, 103 and the server 105. The network 104 may include various types of connections, such as wired, wireless communication links or fiber-optic cables, and the like.

It should be understood that, the number of terminal devices, networks, and servers in FIG. 1 is merely illustrative. There may be any number of terminal devices, networks, and servers based on the implementation needs. For example, the server 105 may be a server cluster composed of a plurality of servers, etc.

A worker may use the terminal devices 101, 102, 103 to interact with the server 105 via the network 104, so as to receive or transmit messages. The terminal devices 101, 102, 103 may be various electronic devices with display screens, including, but not limited to, smartphones, tablet computers, portable computers and desktop computers, digital movie projectors, and the like.

The server 105 may be a server providing various services. For example, a worker sends a modeling request for an identification model of the tire capacity to the server 105 using the terminal device 103 (which may also be the terminal device 101 or 102). The server 105 may obtain tire test data, where the tire test data includes the tire angular velocity, the wheel effective radius, the tire slip angle, the wheel center velocity, the tire longitudinal force, the tire lateral force, and the tire vertical force; a total slip ratio and a normalized tire force is obtained according to the tire test data; a tire capacity corresponding to the total slip ratio and the normalized tire force is obtained according to the tire test data; training is performed using the total slip ratio, the normalized tire force, and the tire capacity through a machine learning algorithm to complete the modeling of the identification model of the tire capacity. The server 105 can display the trained identification model of the tire capacity on the terminal device 103, so that the worker can view the identification model of the tire capacity based on the content displayed on the terminal device 103.

Alternatively, the terminal device 103 (which may also be the terminal device 101 or 102) may be a smart television, a VR (Virtual Reality)/AR (Augmented Reality) helmet display, or a mobile terminal equipped with applications (APP) of navigation, online car appointment, instant messaging, video and the like, such as a smart phone, a tablet computer, etc. The worker can send a modeling request for an identification model of the tire capacity to the server 105 through the smart television, the VR/AR helmet display or the APPs of navigation, online car appointment, instant messaging, and video. The server 105 can obtain the identification model of the tire capacity based on the modeling request for the identification model of the tire capacity, and return the identification model of the tire capacity to the smart television, the VR/AR helmet display or the APPs of navigation, online car appointment, instant messaging, and video, so as to display the identification model of the tire capacity through the smart television, the VR/AR helmet display or the APPs of navigation, online car appointment, instant messaging, and video.

FIG. 2 shows a schematic diagram of a computer system suitable for implementing the electronic device according to embodiments of the present disclosure.

It should be noted that the computer system 200 of the electronic device shown in FIG. 2 is merely an example and should not bring any limitation to the function and use scope of the embodiments of the present disclosure.

As shown in FIG. 2, computer system 200 includes a central processing unit (CPU) 201, which performs various appropriate actions and processing according to programs stored in the read-only memory (ROM) 202 or programs loaded from the storage portion 208 into random access memory (RAM) 203. In RAM203, there is also stored with various programs and data required for system operation. CPU 201, ROM 202 and RAM 203 are connected to each other via bus 204. The input/output (I/O) interface 205 is also connected to bus 204.

The following components are connected to the I/O interface 205: an input portion 206 including a keyboard, mouse, etc.; an output portion 207 including, for example, a cathode ray tube (CRT), a liquid crystal display (LCD), and a speaker; a storage portion 208 including a hard disk or the like; and a communication portion 209 including a network interface card such as a local area network (LAN) card, a modem or the like. The communication portion 209 performs communication processing through a network such as the Internet. Driver 210 is also connected to I/O interface 205 as needed. Removable medium 211, such as magnetic disk, optical disk, magneto-optical disk, semiconductor memory, etc., is installed on the driver 210 as needed to facilitate computer programs read from it being installed into the storage portion 208 as needed.

According to embodiments of the present disclosure, the process described below with reference to the flowchart may be implemented as a computer software program. For example, embodiments of the present disclosure include a computer program product including a computer program carried on a computer-readable storage medium, the computer program including program code for performing the method shown in the flowchart. In such embodiments, the computer program may be downloaded and installed from a network via the communication portion 209, and/or installed from a removable medium 211. When the computer program is executed by the central processing unit (CPU) 201, various functions defined in the methods and/or apparatus of the present disclosure are to be performed.

It should be noted that, the computer-readable storage medium shown in the present disclosure may be a computer-readable signal medium or a computer-readable storage medium or any combination of the two. The computer-readable storage medium may be, such as, but not limited to, an electrical, magnetic, optical, electromagnetic, infrared, or semiconductor system, apparatus, or device, or any combination of them. More specific examples of computer-readable storage medium may include, but are not limited to: electrical connection with one or more wires, portable computer disk, hard disk, random access memory (RAM), read-only memory (ROM), erasable programmable read-only memory (EPROM), or flash memory, optical fiber, portable compact disk read-only memory (CD-ROM), optical storage device, magnetic storage device, or any suitable combination of the foregoing. In the present disclosure, the computer-readable storage medium may be any tangible medium containing or storing a program. The program may be used by or in conjunction with an instruction execution system, apparatus, or device. In the present disclosure, the computer-readable signal medium may include a data signal propagated in baseband or as part of a carrier wave, which carries computer-readable program code. The propagated data signal may take a variety of forms, including, but not limited to, electromagnetic signals, optical signals, or any suitable combination of the foregoing. The computer-readable signal medium may also be any computer-readable storage medium other than the computer-readable storage medium. The computer-readable storage medium may send, propagate, or transmit programs used by or in connection with an instruction execution system, apparatus, or device. The program code contained on the computer-readable storage medium may be transmitted using any suitable medium, including, but not limited to, wireless, wires, optical cables, radio frequency (RF), etc., or any suitable combination of them.

The flowchart and block diagram in the accompanying drawings illustrate the possibly implemented system architecture, functions, and operations of methods, apparatuses, and computer program products according to various embodiments of the present disclosure. At this point, each block in a flowchart or block diagram can represent a module, program segment, or part of code that contains one or more executable instructions for implementing specified logical functions. It should also be noted that in some alternative implementations, the functions selected in the block can also occur in a different order from that selected in the accompanying drawings. For example, two connected blocks as shown can actually be executed in parallel, and sometimes they can also be executed in an opposite order, depending on the function involved. It should also be noted that each block in the block diagram or flowchart, as well as the combination of blocks in the block diagram or flowchart, can be implemented using dedicated hardware-based systems that perform specified functions or operations, or can be implemented using a combination of dedicated hardware and computer instructions.

The modules and/or units and/or subunits described in the embodiments of the present disclosed can be implemented through software, or be implemented through hardware. The described modules and/or units and/or subunits can also be set in a processor. Among them, the names of these modules and/or units and/or subunits do not constitute a restriction to the modules and/or units and/or subunits themselves in a certain situation.

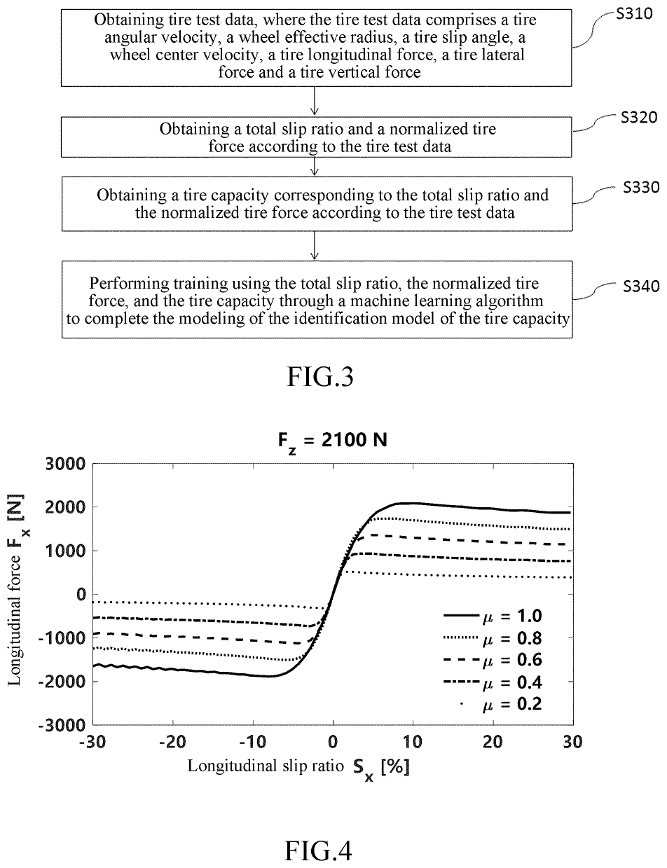

As another aspect, the present disclosure also provides a computer-readable storage medium, which may be included in the electronic device described in the embodiments described above. Alternatively, it can also exist separately without being assembled into the electronic device. The computer-readable storage medium mentioned above carries one or more programs that, when executed by an electronic device, enable the electronic device to implement the method described in the following embodiments. For example, the electronic device can implement various steps as shown in FIG. 3.

In the related art, for example, a machine learning method, a deep learning method and the like can be adopted to carry out modeling of the identification model of the tire capacity, and the application ranges of different methods are different.

FIG. 3 schematically shows a flow chart of the method for modeling the identification model of the tire capacity according to an embodiment of the present disclosure. Method steps of the embodiments of the present disclosure may be performed by a terminal device, or performed by a server, or interactively performed by a terminal device and a server, for example, performed by the server 105 in FIG. 1 described above, but the present disclosure is not limited to this.

In step S310, tire test data is obtained, where the tire test data includes a tire angular velocity, a wheel effective radius, a tire slip angle, a wheel center velocity, a tire longitudinal force, a tire lateral force, and a tire vertical force.

In this step, a terminal device or server obtains the tire test data, where the tire test data includes the tire angular velocity, the wheel effective radius, the tire slip angle, the wheel center velocity, the tire longitudinal force, the tire lateral force, and the tire vertical force.

FIG. 4 shows a diagram of curves of the tire longitudinal force versus the longitudinal slip ratio under five types of road surface conditions obtained through tests. Two conclusions can be drawn from FIG. 4: firstly, the maximum tire force and its corresponding slip ratio depend on the current tire-road friction; secondly, for different road conditions, the tire properties in the linear region are almost the same, resulting in difficulty in identifying the road friction coefficient in the linear region.

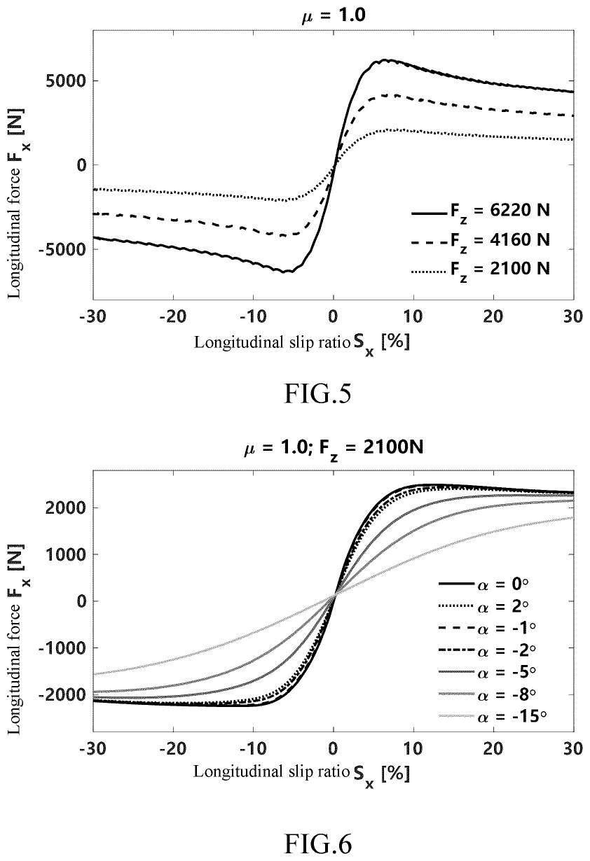

FIG. 5 shows the relationship between the tire longitudinal force and the longitudinal slip ratio under different loads obtained through tests. The result of FIG. 5 shows that the vertical force has effects on the slope of the curve (longitudinal stiffness) and the maximum tire force, but the slip ratios corresponding to the maximum tire force under different loads are almost the same.

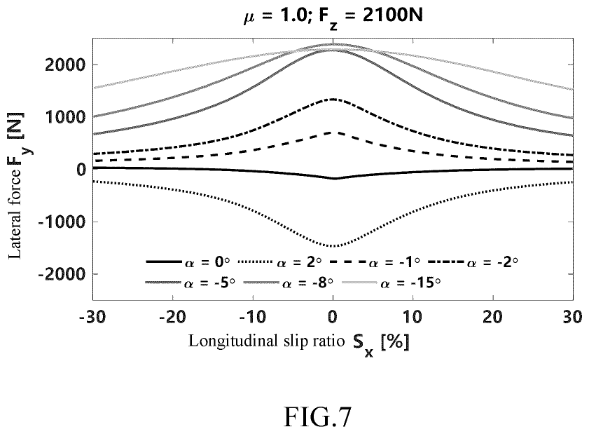

FIG. 6 shows a diagram of curves of the tire longitudinal force versus the longitudinal slip ratio at different slip angles obtained through tests, that is, the tire properties under combined slip conditions (which may include condition of lateral force and longitudinal force, for example, vehicle turning acceleration). When the tire load is 2100N and the road adhesion coefficient (friction coefficient) is 1.0, the tire longitudinal force is represented as a function of the slip ratios at different slip angles. The result shows that, when the absolute value of the slip angle increases, the slope in the linear region decreases. FIG. 7 shows a diagram of curves of the tire lateral force versus longitudinal slip ratio at different slip angles when the tire load is 2100N and the road adhesion coefficient is 1.0 under combined slip conditions obtained through tests.

As can be seen from FIG. 4 and FIG. 5, the mechanical properties of the tire under longitudinal slip condition and the tire capacity may be determined based on the curve when the tire force reaches a maximum under any road friction or load. However, for the combined slip conditions as shown in FIG. 6 and FIG. 7, even if the tire force information can be obtained in advance, it is difficult to determine the tire capacity and determine the current working region in which the tire is located by comparison between curves of the longitudinal force and the lateral force versus the longitudinal slip ratio. This means that it is not easy to generate corresponding training data by marking of the tire capacity for off-line tire test data under combined slip conditions.

In one embodiment, the tire test data under different road conditions, different friction coefficients, different vehicle velocities and different loads are obtained through tests.

In embodiments of the present disclosure, the terminal device may be implemented in various forms. For example, the terminals described in the present disclosure may include mobile terminals such as mobile phone, tablet computer, notebook computer, palm computer, personal digital assistant (PDA), portable media player (PMP), apparatus for modeling an identification model of a tire capacity, wearable equipment, intelligent bracelet, pedometer, robot, unmanned vehicle and the like, and fixed terminals such as digital TV (television), desktop computer and the like.

In step S320, a total slip ratio and a normalized tire force are obtained according to the tire test data.

In this step, the terminal device or server obtains the total slip ratio and the normalized tire force according to the tire test data.

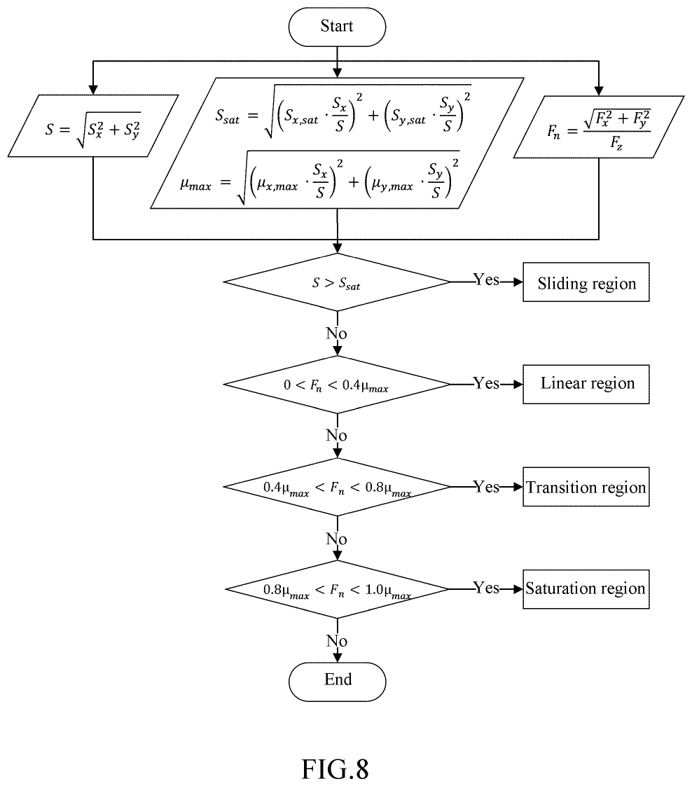

FIG. 8 illustrates a method for unified processing of the tire data and a method for determining the tire capacity. Referring to FIG. 8, the total slip ratio S is obtained according to the longitudinal slip ratio Sₓ and the lateral slip ratio S_{y}. The longitudinal slip ratio Sₓ and the lateral slip ratio S_{y} are defined as follows:

$$\{ \begin{matrix}{S}_{x} = \frac{- {V}_{s x}}{Ω {R}_{e}} = \frac{Ω {R}_{e} - V cos α}{Ω {R}_{e}} \\ {S}_{y} = \frac{- {V}_{s y}}{Ω {R}_{e}} = - \frac{V sin α}{Ω {R}_{e}}\end{matrix} \qquad ( 1 )$$

Among them, Ω is the tire angular velocity; Rₑ is the wheel effective radius; α is the tire slip angle; V is the wheel center velocity; Vₛₓ and V_{sy} are the tire longitudinal sliding velocity and the tire lateral sliding velocity; where, the wheel center velocity V is a moving velocity of a tire central axis relative to ground.

The total slip ratio S is calculated by the following equation:

S=\sqrt{Sₓ²+S_{y}²} (2)

Secondly, the tire longitudinal force Fₓ is combined with the tire lateral force F_{y}, and normalized through a tire vertical force F_{z} to obtain the normalized tire force Fₙ:

$${F}_{n} = \frac{\sqrt{{F}_{x}^{2} + {F}_{y}^{2}}}{{F}_{z}} \qquad ( 3 )$$

In step S330, a tire capacity corresponding to the total slip ratio and the normalized tire force is obtained according to the tire test data.

In this step, the tire capacity corresponding to the total slip ratio and the normalized tire force is obtained according to the tire test data. In one embodiment, the tire capacity of a linear region, a transition region, a saturation region, and a sliding region corresponding to the total slip ratio and the normalized tire force is obtained according to the tire test data. In one embodiment, the linear region and the transition region can be combined into a linear region, and then, the tire capacity of the linear region, the saturation region and the sliding region corresponding to the total slip ratio and the normalized tire force is obtained according to the tire test data.

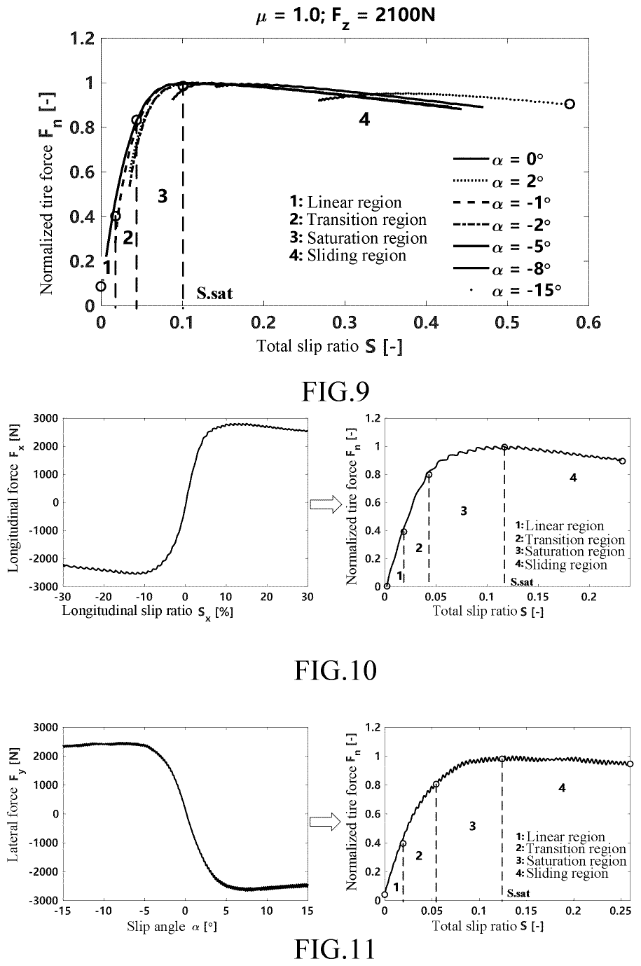

FIG. 9 shows a schematic diagram of a classification method for identifying the tire capacity according to a data normalization method under combined slip conditions on a dry road surface condition. Referring to FIG. 9, the complex mechanical properties of the tire under different loads and combined slip conditions can be compressed into a curve by normalizing the relationship between the tire force Fₙ and the total slip ratio S. It is obvious that the “single” curve is convenient for classifying (marking) the tire capacity corresponding to the data. Region 1 to Region 4 in FIG. 9 respectively correspond to the linear region, the transition region, the saturation region and the sliding region, and these regions are determined by the maximum normalized tire force F_{n,max} and a corresponding saturated total slip ratio Sₛₐₜ. According to equation (3), the maximum normalized tire force F_{n,max} is also the maximum friction coefficient μₘₐₓ under the combined slip conditions. FIG. 9 gives the complete tire properties at different combinations of the slip ratio and the slip angle. However, for individual combined slip conditions, taking a curve with a slip angle of −5 deg as an example, we still do not know the accurate maximum friction coefficient and the corresponding saturated total slip ratio. Therefore, under the combined slip conditions, the maximum friction coefficient μₘₐₓ and the saturated total slip ratio Sₛₐₜ are calculated using the directional friction coefficient and the slip ratio.

$${μ}_{max} = \sqrt{{( {μ}_{x , max} \cdot \frac{{S}_{x}}{S} )}^{2} + {( {μ}_{y , max} \cdot \frac{{S}_{y}}{S} )}^{2}} \qquad ( 4 )$$

$${S}_{s a t} = \sqrt{{( {S}_{x , sat} \cdot \frac{{S}_{x}}{S} )}^{2} + {( {S}_{y , sat} \cdot \frac{{S}_{y}}{S} )}^{2}} \qquad ( 5 )$$

Among them, μ_{x,max} and μ_{y,max} are the tire longitudinal friction coefficient and the tire lateral friction coefficient, S_{x,sat} and S_{y,sat} are the saturated slip ratio under the pure longitudinal slip condition and the saturated slip ratio under the pure lateral slip condition.

After the normalized tire properties and the saturation total slip ratio Sₛₐₜ are obtained, the tire capacity can be marked into four categories, namely, the linear region, the transition region, the saturation region and the sliding region. The classification method is as shown in FIG. 8. Sₛₐₜ is used as a cutoff point, it is regarded as the sliding region when S>Sₛₐₜ. The other three regions are all within the range of S<Sₛₐₜ, and the specific region is determined through the magnitude of the normalized tire force Fₙ. It is regarded as the liner region when 0<Fₙ<0.4μₘₐₓ. It is regarded as the transition region when 0.4μₘₐₓ<Fₙ<0.8μₘₐₓ. It is regarded as the saturation region when 0.8μₘₐₓ<Fₙ<1.0μₘₐₓ.

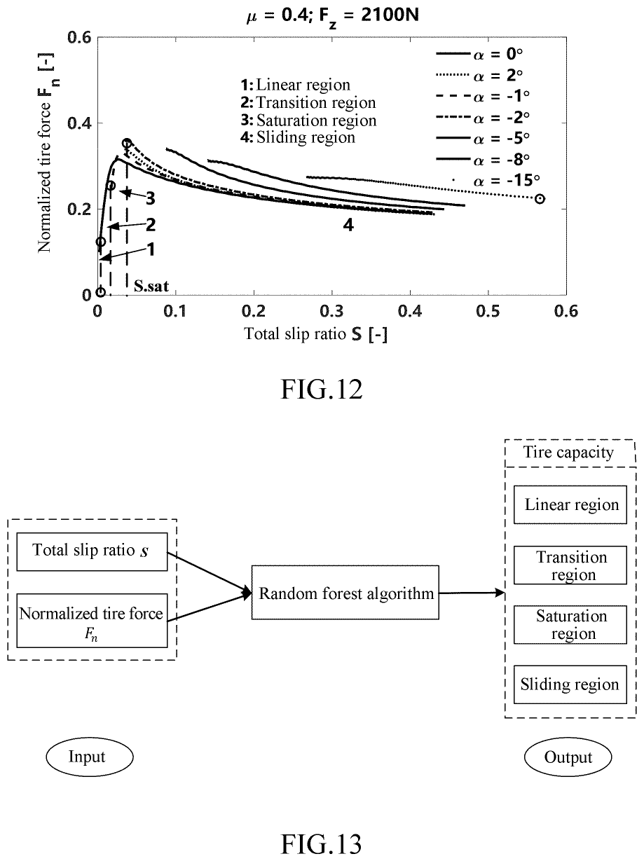

FIG. 9 shows a schematic diagram of tire capacity classification results obtained by calculating tire test data under combined slip conditions according to the method of FIG. 8. FIG. 9 shows standardized tire capacities at different slip angles under combined slip conditions. This unified method for classification under typical driving conditions has significant advantages that it can represent both pure working condition and combined slip conditions. FIG. 10 shows a schematic diagram of tire capacity classification results obtained by calculating tire test data under pure longitudinal slip condition according to the method of FIG. 8. FIG. 11 shows a schematic diagram of tire capacity classification results obtained by calculating tire test data under pure lateral slip condition according to the method of FIG. 8. FIG. 10 and FIG. 11 are special cases of the pure longitudinal slip condition and the pure lateral slip condition. It can be seen from FIG. 10 and FIG. 11 that the method for data processing is unified and is suitable for pure working condition. FIG. 12 is a diagram of curves obtained by processing the tire test data collected on a snowy road surface (friction coefficient of 0.4) through a unified method.

In step S340, training is performed using the total slip ratio, the normalized tire force, and the tire capacity through a machine learning algorithm to complete modeling of the identification model of the tire capacity.

In this step, the terminal device or server uses the total slip ratio, the normalized tire force and the tire capacity to perform training through a machine learning algorithm to complete modeling of the identification model of the tire capacity. In one embodiment, training is performed using the total slip ratio, the normalized tire force, and the tire capacity through a random forest algorithm to complete modeling of the identification model of the tire capacity.

The random forest algorithm belongs to the field of supervised learning in machine learning. Through bootstrap resampling technique, it extracts n samples randomly with replacement from the training sample set to generate a new training sample set for training a decision tree, and then generates m decision trees to constitute a random forest. Typically, the algorithm selected is a classification and regression tree (CART). The random forest algorithm in the present disclosure is implemented through a randomForest package in the R language, and can select and adjust parameters such as the number of decision trees, the number of split attributes and the like to achieve algorithm optimization. FIG. 13 is a schematic diagram of data-driven tire capacity identification adopting a random forest algorithm, where the input of the algorithm is the total slip ratio and the actual normalized total force, and the output is four tire capacity regions, respectively the linear region, the transition region, the saturation region and the sliding region. For example, data corresponding to the curves of FIG. 9 to FIG. 12 are used for performing training. Other machine learning algorithms may also be used here to address this classification problem, such as decision tree, random forest, neural network, deep learning and the like. Random forest algorithm can select and adjust parameters such as the number of the decision trees, the number of nodes and the like to realize algorithm optimization, where the used parameters can be that: the number of the decision trees is 20; the minimum leaf size (MinLeafSize) is 1000; and the number of nodes is 145.

FIG. 9 and FIG. 12 are diagrams of curves obtained by processing the tire test data collected respectively on a dry asphalt road surface (with friction coefficient of 1.0) and a snowy road surface (with friction coefficient of 0.4) through a unified method. The applied neural network algorithm performs classifying and learning for input data (the total slip ratio and the normalized tire force) of different road surface, according to the total slip ratio, the normalized tire force and tire capacity regions corresponding to the output. Among them, the total slip ratio and the normalized tire force under two road surfaces are also in one-to-one correspondence. For example, saturation slip ratios S sat under different road conditions are different in magnitude. Compared with dry asphalt road surface, the saturation slip ratio of the snowy road surface is smaller, and the magnitudes of the normalized tire forces corresponding to different tire capacity regions are also smaller. In the real vehicle prediction process, the trained algorithm can judge according to the one-to-one correspondence between the total slip ratio and the normalized tire force, so as to determine whether it is on the dry asphalt road surface or the snowy road surface.

In one embodiment, the method for modeling the identification model of the tire capacity further includes testing the identification model of the tire capacity using the test data to detect a prediction level of the identification model of the tire capacity.

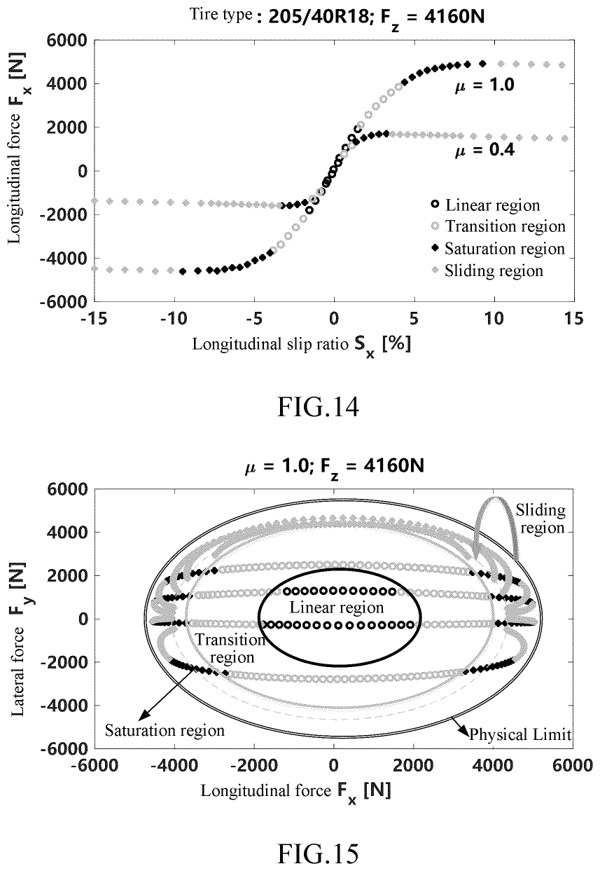

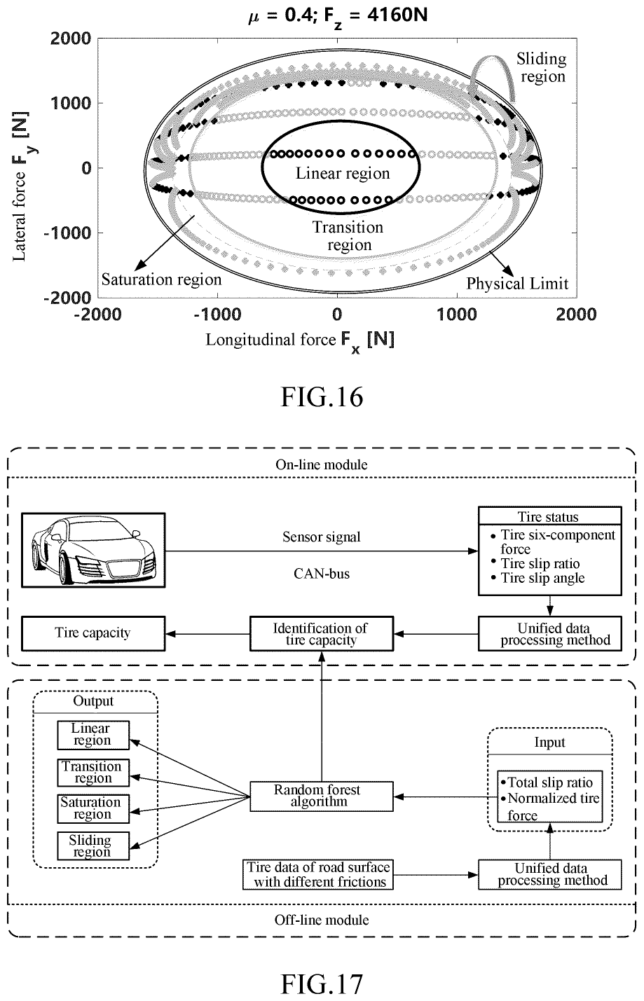

FIG. 14 to FIG. 16 illustrate the identification results of the tire capacity when the tire data test set is input into a trained network model (the identification model of the tire capacity). Among them, FIG. 14 is an identification result of the tire capacity under pure longitudinal slip condition. FIG. 15 is an identification result of the tire capacity under combined slip conditions, where the tire data collected under the dry road surface is used as input. FIG. 16 is an identification result of the tire capacity under combined slip conditions, where the tire data collected under the icy and snowy road surface is used as input. As can be seen from FIG. 14, the model can automatically classify the tire capacities with different road frictions and accurately capture the key features of tire properties under different road conditions. The determination results of pure longitudinal slip condition will have broad prospects for ABS/ESC applications. More important results as shown in FIG. 15 and FIG. 16 are that, under combined slip conditions, whether under dry road surface or under snowy condition, the overall longitudinal and lateral performance of the tire (i.e., tire force ellipse) has been divided into four regions through the trained algorithms. The working status of the tire can be readily determined from these results. This may be sent to the active safety system that which region the current tire status is in and how far it is from the tire physical limit. By using the identification result of the tire capacity under combined slip conditions, vehicle performance under extreme working conditions or vehicle dynamics integrated control in both the longitudinal and lateral directions may be improved.

The present disclosure provides a method for modeling an identification model of the tire capacity. The established identification model of the tire capacity can identify the tire capacity under all working conditions, and has certain generalization capability on different tire brands and types within a certain range.

The present disclosure includes a method for using an identification model of the tire capacity, where the method includes the following steps:
The tire data is obtained;
A total slip ratio and a normalized tire force is obtained according to the tire data;
The tire capacity is obtained using the identification model of the tire capacity according to the total slip ratio and the normalized tire force.

In one embodiment, the tire capacity of a linear region, a transition region, a saturation region and a sliding region is obtained using the identification model of the tire capacity according to the total slip ratio and the normalized tire force. In one embodiment, the linear region and the transition region may be merged into a linear region, and then, the tire capacity of the linear region, the saturation region and the sliding region is obtained using the identification model of the tire capacity according to the total slip ratio and the normalized tire force.

FIG. 17 shows a flow chart of vehicle-mounted operation of a tire capacity identification module. For the on-line application of vehicles, real-time estimated values such as tire angular velocity, wheel effective radius, tire slip angle, wheel center velocity, tire longitudinal force, tire lateral force, tire vertical force and the like may be obtained from the vehicle CAN bus. These estimated values are processed by a data standard normalization module and sent to a data-driven tire capacity identification module, the output of which is a real-time identification result of the tire capacity under any driving conditions and any road conditions.

Vehicle control systems in the field of modern automotive engineering have developed some mature technologies, for example, the anti-lock brake system (ABS), the electronic stability control system (ESC) and the advanced driver assistance system (ADAS) and the like have been widely applied to passenger vehicles and commercial vehicles. As the demand for control systems increases, the performance analysis of the whole vehicle becomes more and more important. The tire is used as the only part of the whole vehicle for interaction with road, and the performance analysis of the tire determines the status performance of the whole vehicle. It has great reference value for evaluating the performance of the whole vehicle to enable to grasp the current capacity of the tire in real time.

Specific application scenarios are described below:

Scenario 1: when the adhesion road surface changes suddenly, if the friction coefficient of adhesion road surface is reduced, then the tire is easy to slip, resulting in a reduction in driving force and accompanying uncontrollable risk of the vehicle. When the tire capacity region can be estimated in real time, the total slip ratio of the tire is controlled by a controller, and the tire slip ratio can be timely controlled in a tire capacity safety region (which can be controlled in a linear region, a transition region or a saturation region according to the driving style) when the friction coefficient of the adhesion road surface is reduced, so that the adhesion road surface suddenly changed can be efficiently and safely passed through.

Scenario 2: when driving on a low adhesion road surface (e.g., snowy, icy road surface), whether turning, braking or driving, the tire is easy to slip, so that uncontrollable accidents happen to the vehicle. When the tire capacity region can be estimated in real time, the total slip ratio of the tire is controlled by a controller, and the tire capacity is always kept in a safe region for stable driving. Alternatively, the current tire capacity region may be evaluated to determine if there is sufficient tire force to enable the driver to obtain additional operating space to steer the vehicle.

Scenario 3: In a vehicle advanced auxiliary driving system and an automatic driving control system, the travelling track of the vehicle needs to be planned in real time. In addition to the constraint of a lane line and surrounding vehicles, the dynamic status of the vehicles is also an important consideration factor for path planning of the intelligent vehicle, for example, whether it will cause the instability of the vehicle under overtaking, turning and other working conditions. The instability risk of the vehicle can be pre judged in advance by utilizing the real-time tire capacity estimation, improving travelling safety of the intelligent vehicle.

To sum up, the method for estimating the tire capacity in real time, provided by the present disclosure, can widen the application scenarios of automobile electronic control system, advanced driving auxiliary system and intelligent driving system, improving the safety of a vehicle, particularly under complex working conditions and on low adhesion road surfaces. On the other hand, capacity (in the linear region, the transition region, the saturation region, and the sliding region) for each wheel may be provided to the driver, or the tire capacity is converted into the capacity of the whole vehicle. The tire capacity and the capacity of the whole vehicle are displayed on the instrument panel in real time, for a driver to master them in real time and to carry out some extreme driving operations independently under the condition of ensuring that the whole vehicle is not out of control, so as to obtain driving pleasure.

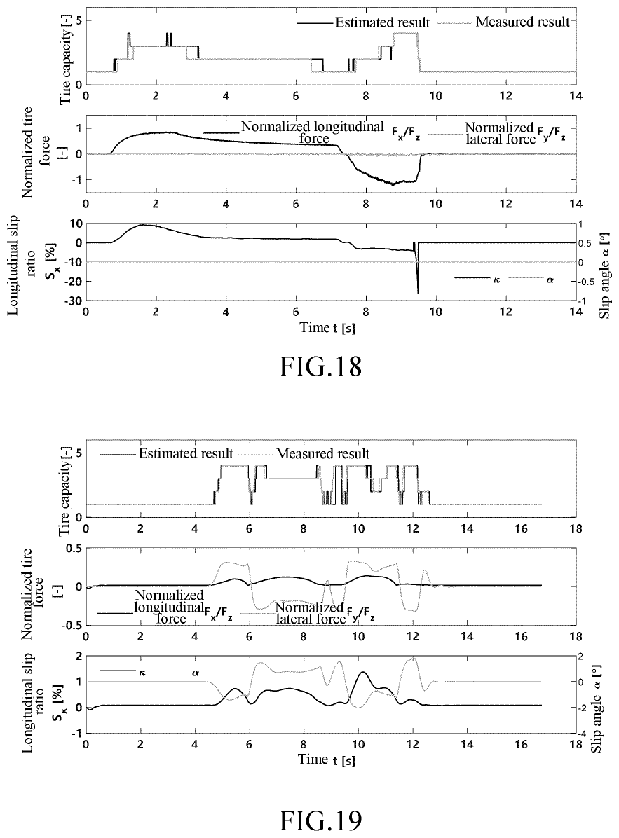

In one embodiment, real vehicle data is tested to verify the performance of the identification model of tire capacity. FIG. 18 and FIG. 19 are identification results of the tire capacity for actual real vehicle data. FIG. 18 is an identification result of the tire capacity obtained with test data collected under vehicle driving/braking conditions on a dry road surface as input. FIG. 19 is an identification result of tire capacity obtained with test data collected under vehicle double shift working condition on icy and snowy roads as input. As can be seen from FIG. 18 and FIG. 19, for road surfaces in various cases, whether the tire capacity is in a linear region due to a smaller road surface excitation when the vehicle is started, or in a sliding region due to a larger road surface excitation under a maximum driving/braking force working condition or a dual shift moving working condition, the method can identify the tire capacity correctly.

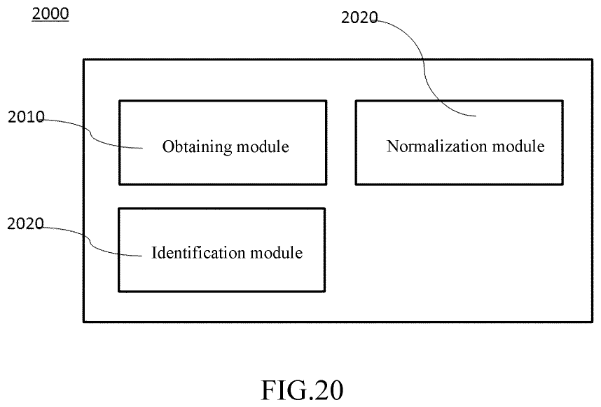

FIG. 20 schematically illustrates a block diagram of an apparatus for identifying the tire capacity according to one embodiment of the present disclosure. The apparatus 2000 for identifying the tire capacity provided by the embodiments of the present disclosure may be disposed on a terminal device, or on the server, or partially on the terminal device and partially on the server. For example, it may be disposed on the server 105 in FIG. 1, but the present disclosure is not limited to this.

The apparatus 2000 for identifying the tire capacity provided by the embodiments of the present disclosure may include an obtaining module 2010, and a normalization module 2020 and an identification module 2030.

Among them, the obtaining module is configured to obtain tire data. The normalization module is configured to obtain a total slip ratio and a normalized tire force according to the tire data. The identification module is configured to obtain a tire capacity using an identification model of the tire capacity according to the total slip ratio and the normalized tire force.

According to embodiments of the present disclosure, the above apparatus 2000 for identifying the tire capacity may be used in the method for using the identification model of tire capacity described in the present disclosure.

It will be appreciated that, the obtaining module 2010, the normalization module 2020 and the identification module 2030 may be merged and implemented in one module. Or, any one of the modules may be divided into a plurality of modules. Or, at least a portion of the functions of one or more of these modules may be combined with at least a portion of the functions of other modules, and may be implemented in one module. According to embodiments of the present disclosure, at least one of the obtaining module 2010, and the normalization module 2020 and the identification module 2030 may be at least partially implemented as hardware circuitry, such as a field programmable gate array (FPGA), a programmable logic array (PLA), a system on chip, a system on substrate, a system on package, an application specific integrated circuit (ASIC), or may be implemented in hardware or firmware such as any other reasonable ways of integrating or encapsulating the circuit, or may be implemented in an appropriate combination of implementation ways of software, hardware, and firmware. Alternatively, at least one of the obtaining module 2010, the normalization module 2020 and the identification module 2030 may be at least partially implemented as a computer program module that, when executed by a computer, may perform the functions of the corresponding modules.

It should be noted that, although several modules, units, and subunits of the apparatus for performing actions have been mentioned in the detailed description above, such division is not mandatory. In practice, in accordance with embodiments of the present disclosure, the features and functions of two or more modules, units, and subunits described above may be concretized in one module, unit, and subunit. Whereas, the features and functions of one module, unit, and subunit described above may be further divided into a plurality of modules, units, and subunits to concretized.

From the foregoing description of the embodiments, those skilled in the art will readily appreciate that the example embodiments described here may be implemented by software, it can also be implemented by software in conjunction with the necessary hardware. Thus, the technical scheme of the embodiments of the present disclosure can be embodied in the form of a software product. The software product may be stored on a non-volatile storage medium (which may be a CD-ROM, a USB flash disk, a mobile hard disk, or the like) or on a network, including several instructions for causing a computing device (which may be a personal computer, a server, a touch terminal, or a network device, or the like) to perform the method according to embodiments of the present disclosure.

Those skilled in the art, upon consideration of the specification and practice of the disclosure disclosed here, other embodiments of the present disclosure will readily be apparent. This application is intended to cover any variations, uses, or adaptations of the present disclosure. These variations, uses, or adaptations follow the generic principles of the present disclosure and include common knowledge or conventional technical means in the art not disclosed by the present disclosure. The specification and the embodiments are to be considered as examples, and the true scope and spirit of the present disclosure are pointed out by the following claims.

It is to be understood that the present disclosure is not limited to the precise construction described above and shown in the drawings, and that various modifications and variations without departing from the scope of the present disclosure, may be made. The scope of the present disclosure is limited only by the appended claims

1. A method for modeling an identification model of a tire capacity, comprising:
obtaining tire test data, wherein the tire test data comprises a tire angular velocity, a wheel effective radius, a tire slip angle, a wheel center velocity, a tire longitudinal force, a tire lateral force and a tire vertical force;
obtaining a total slip ratio and a normalized tire force according to the tire test data;
obtaining a tire capacity corresponding to the total slip ratio and the normalized tire force according to the tire test data; and
performing training using the total slip ratio, the normalized tire force, and the tire capacity through a machine learning algorithm to complete the modeling of the identification model of the tire capacity.

2. The method according to claim 1, wherein obtaining the tire test data comprises:
obtaining the tire test data under a vehicle condition of different road conditions, different friction coefficients, different vehicle velocities and different loads.

3. The method according to claim 1, wherein obtaining the tire capacity corresponding to the total slip ratio and the normalized tire force according to the tire test data comprises:
obtaining the tire capacity of a linear region, a transition region, a saturation region, and a sliding region corresponding to the total slip ratio and the normalized tire force according to the tire test data; or
obtaining the tire capacity of a linear region, a saturation region, and a sliding region corresponding to the total slip ratio and the normalized tire force according to the tire test data.

4. The method according to claim 1, wherein obtaining the total slip ratio and the normalized tire force according to the tire test data comprises:
determining the total slip ratio according to a following equation:
S=\sqrt{Sₓ²+S_{y}²},
wherein, Sₓ is a longitudinal slip ratio, S_{y} is a lateral slip ratio.

5. The method according to claim 4, wherein obtaining the total slip ratio and the normalized tire force according to the tire test data further comprises:
determining Sₓ and S_{y} according to a following equation:
$$\{ \begin{matrix}{S}_{x} = \frac{- {V}_{s x}}{Ω {R}_{e}} = \frac{Ω {R}_{e} - V cos α}{Ω {R}_{e}} \\ {S}_{y} = \frac{- {V}_{s y}}{Ω {R}_{e}} = - \frac{V sin α}{Ω {R}_{e}}\end{matrix} ,$$
wherein Ω is the tire angular velocity; Rₑ is the wheel effective radius; α is the tire slip angle; V is the wheel center velocity; Vₛₓ and V_{sy} are a tire longitudinal sliding velocity and a tire lateral sliding velocity, respectively; wherein the wheel center velocity V is a moving velocity of a tire central axis relative to ground.

6. The method according to claim 1, wherein obtaining the total slip ratio and the normalized tire force according to the tire test data comprises:
determining the normalized tire force according to a following equation:
$${F}_{n} = \frac{\sqrt{{F}_{x}^{2} + {F}_{y}^{2}}}{{F}_{z}} ,$$
wherein Fₓ is the tire longitudinal force, F_{y} is the tire lateral force, and F_{z} is the tire vertical force.

7. The method according to claim 1, wherein performing training using the total slip ratio, the normalized tire force, and the tire capacity through the machine learning algorithm to complete the modeling of the identification model of the tire capacity comprises:
performing training using the total slip ratio, the normalized tire force, and the tire capacity through a random forest algorithm to complete the modeling of the identification model of the tire capacity.

8. A method for using an identification model of a tire capacity, comprising:
obtaining tire data;
obtaining a total slip ratio and a normalized tire force according to the tire data; and
obtaining the tire capacity using the identification model of the tire capacity according to the total slip ratio and the normalized tire force.

9. The method according to claim 8, wherein obtaining the tire capacity using the identification model of the tire capacity according to the total slip ratio and the normalized tire force comprises:
obtaining the tire capacity of a linear region, a transition region, a saturation region, and a sliding region using the identification model of the tire capacity according to the total slip ratio and the normalized tire force; or
obtaining the tire capacity of a linear region, a saturation region, and a sliding region using the identification model of the tire capacity according to the total slip ratio and the normalized tire force.

10. (canceled)

11. An electronic device, comprising:
one or more processors;
a storage apparatus, configured to store one or more programs that, when executed by the one or more processors, cause the one or more processors to implement a method for modeling an identification model of a tire capacity, comprising:
obtaining tire test data, wherein the tire test data comprises a tire angular velocity, a wheel effective radius, a tire slip angle, a wheel center velocity, a tire longitudinal force, a tire lateral force and a tire vertical force;
obtaining a total slip ratio and a normalized tire force according to the tire test data;
obtaining a tire capacity corresponding to the total slip ratio and the normalized tire force according to the tire test data; and
performing training using the total slip ratio, the normalized tire force, and the tire capacity through a machine learning algorithm to complete the modeling of the identification model of the tire capacity.

12. A computer-readable storage medium having stored with a computer program that, when executed by a processor, implements the method according to claim 1.

13. The electronic device according to claim 11, wherein obtaining the tire test data comprises:
obtaining the tire test data under a vehicle condition of different road conditions, different friction coefficients, different vehicle velocities and different loads.

14. The electronic device according to claim 11, wherein obtaining the tire capacity corresponding to the total slip ratio and the normalized tire force according to the tire test data comprises at least one of:
obtaining the tire capacity of a linear region, a transition region, a saturation region, and a sliding region corresponding to the total slip ratio and the normalized tire force according to the tire test data; or
obtaining the tire capacity of a linear region, a saturation region, and a sliding region corresponding to the total slip ratio and the normalized tire force according to the tire test data.

15. The electronic device according to claim 11, wherein obtaining the total slip ratio and the normalized tire force according to the tire test data comprises:
determining the total slip ratio according to a following equation:
S=\sqrt{S_{y}²+S_{y}²},
wherein, Sₓ is a longitudinal slip ratio, S_{y} is a lateral slip ratio.

16. The electronic device according to claim 15, wherein obtaining the total slip ratio and the normalized tire force according to the tire test data further comprises:
determining Sₓ and S_{y} according to a following equation:
$$\{ \begin{matrix}{S}_{x} = \frac{- {V}_{s x}}{Ω {R}_{e}} = \frac{Ω {R}_{e} - V cos α}{Ω {R}_{e}} \\ {S}_{y} = \frac{- {V}_{s y}}{Ω {R}_{e}} = - \frac{V sin α}{Ω {R}_{e}}\end{matrix} ,$$
wherein Ω is the tire angular velocity; Rₑ is the wheel effective radius; α is the tire slip angle; V is the wheel center velocity; Vₛₓ and V_{sy} are a tire longitudinal sliding velocity and a tire lateral sliding velocity, respectively; wherein the wheel center velocity V is a moving velocity of a tire central axis relative to ground.

17. The electronic device according to claim 11, wherein obtaining the total slip ratio and the normalized tire force according to the tire test data comprises:
determining the normalized tire force according to a following equation:
$${F}_{n} = \frac{\sqrt{{F}_{x}^{2} + {F}_{y}^{2}}}{{F}_{z}} ,$$
wherein Fₓ is the tire longitudinal force, F_{y} is the tire lateral force and F_{z} is the tire vertical force.

18. The electronic device according to claim 11, wherein performing training using the total slip ratio, the normalized tire force, and the tire capacity through the machine learning algorithm to complete the modeling of the identification model of the tire capacity comprises:
performing training using the total slip ratio, the normalized tire force, and the tire capacity through a random forest algorithm to complete the modeling of the identification model of the tire capacity.

19. An electronic device, comprising:
one or more processors;
a storage apparatus, configured to store one or more programs that, when executed by the one or more processors, cause the one or more processors to implement the method according to claim 8.

20. The electronic device according to claim 19, wherein obtaining the tire capacity using the identification model of the tire capacity according to the total slip ratio and the normalized tire force comprises at least one of:
obtaining the tire capacity of a linear region, a transition region, a saturation region, and a sliding region using the identification model of the tire capacity according to the total slip ratio and the normalized tire force; or
obtaining the tire capacity of a linear region, a saturation region, and a sliding region using the identification model of the tire capacity according to the total slip ratio and the normalized tire force.

21. A computer-readable storage medium having stored with a computer program that, when executed by a processor, implements the method according to claim 8.
